(19) United States
(12) Patent Application Publication
(10) Pub. No.: US 2019/0279276 A1
(43) Pub. Date: Sep. 12, 2019

(54) System and Method for Delivery and Binding of Digital Gifts with Customizable Digital Challenges

(71) Applicant: Anna P. Leano, Elk Grove, CA (US)

(72) Inventor: Anna P. Leano, Elk Grove, CA (US)

(21) Appl. No.: 16/298,745

(22) Filed: Mar. 11, 2019

Related U.S. Application Data
(60) Provisional application No. 62/641,843, filed on Mar. 12, 2018.

(51) Int. Cl. G06Q 30/06; A63F 13/80; H04W 4/029

(52) U.S. Cl. CPC G06Q 30/0633; G06T 19/006; H04W 4/029; A63F 13/80

(57) ABSTRACT

A mobile and network-based computer-implemented digital system and method for augmenting cognitive retention of transactions associated with the delivery of digital gifts, emphasizing gifting experiences via fun games. A target recipient of a digital gift receives a notification from the system on behalf of a gift provider to engage in a digital game challenge. Upon successful completion of the digital game challenge, the recipient receives a digital gift.

### CROSS REFERENCE TO RELATED APPLICATIONS

This application claims the benefit of U.S. Provisional Application No. 62/641,843, filed Mar. 12, 2018.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD

The inventive subject matter described herein is related to systems and methods for delivery of gifts. More particularly, the inventive subject matter is directed to a system and method to cognitively enhance and augment a recipient's experience with delivery and receipt of a digital or tangible gift via gaining.

### BACKGROUND

We live in an extremely fast-paced world where the act and process of “giving” or “gifting” to others can occur at such a rapid clip that the actual gifting experience tends to be quickly forgotten by both the gift provider and the recipient of the gift.

The ability to use eCommerce to order, ship, deliver and gift-wrap products is swiftly becoming the norm in today's society. Unfortunately, the swiftness associated with all aspects of these digital gifting transactions tends to minimize the cognitive retention of the transaction. Thus, the emotional weight, and consequently, the cognitive retention, of the intentions of the gift provider by the targeted recipient is minimized.

Methods for providing digital gifts today typically involve the delivery of an email that includes an image, music or simple video with access to a digital gift card. The recipient of the digital gift is no more than that of a passive observer.

This problem of momentary retention of a digital gifting transaction, particularly in the context of one party providing something of a gift to another party via a digital gifting transaction, such as via an “eGift card,” would benefit from a system and method that enhances memory retention of the transaction.

### SUMMARY

In view of the foregoing described needs, an aspect of the inventive subject matter is directed to a novel implementation of a computer-implemented system and method to enhance and augment cognitive retention of digital gifting transactions by binding digital gifts with a computerized game. The system and method according to the inventive subject matter orchestrates the delivery and management of a tactile and kinetic interactive experience for the recipient during the gifting experience by engaging the recipient in one or more digital challenges. In one embodiment, the system provides the recipient with access to an electronic game challenge that the recipient engages in an attempt to gain access to the digital gift. It also provides the purchaser or gift provider with the experience of “thoughtful” choice in picking the challenge to present to the recipient, thereby enhancing the memory of the gifting experience for the gift provider as well.

An individual or group of individuals, hereinafter referred to as a “gift provider”, may access a software module to orchestrate the purchase and delivery of a digital gift to one or more recipients, hereinafter referred to as a “recipient”. Upon selection of a desired digital gift by the gift provider through the software module, the system provides access for the gift provider to themed game challenges appropriate to the demographics or occasion associated with the recipient and the particular digital gift. The gift provider selects from the presented inventory of game challenges. Upon completion of the game challenge selection, the system then causes a package to be generated for delivery to the targeted recipient via digital means wherein the package digitally encapsulates data and logical instructions associated with the selected challenge and ultimate delivery of the digital gift.

The inventive subject matter described herein provides digital solutions, both mobile and web-based, for augmenting cognitive retention of transactions associated with the delivery of digital and tangible products, including gifts and other items, through various digital media and communication channels. These channels leverage the capabilities and resources of both brick and mortar vendors and e-Commerce vendors, particularly allowing brick and mortar vendors to participate effectively in a digital sales transaction.

The system includes a software application comprising one or more software modules deployable on a desktop, laptop, tablet, smartphone or other computing device wherein the system facilitates the delivery of gifts in a manner to augment cognitive retention of the transaction. The software application may be deployed as an independent software application or in conjunction with one or more other software applications, including ecommerce applications, social media applications, digital download and gift card applications.

The inventive subject matter comprises a mobile and Internet-deployable system and method to support enhanced delivery of packages to augment cognitive retention of the transaction and receipt of a gift or package by a recipient. In one aspect, the system and method may be integrated and deployed in association with wedding event planning services, thereby simplifying the process of gift-giving and creating a longer-lasting impression in the memory of the target recipient.

In another aspect, the system and method promote long-term cognitive retention of a gifting transaction by presenting a digital challenge to a recipient requiring the recipient to generate a plurality of responses that will strengthen a recipient's memory trace associated with the receipt of the gift

In one embodiment, a target recipient of a gift receives a notice from a source to engage in a challenge. Upon successful completion of the challenge, the successful recipient is provided one or more means by which to obtain their gift. The interaction of the target recipient with the mobile and web-based solution is branded in a manner to reinforce the cognitive retention of the purpose and source of the digital gift. The inventive subject matter facilitates digitally-delivered interactive experiences to produce tactile interaction on a physical computing device to create an effective memory bridge between the original receipt of the notice of the gift and the ultimate receipt of the actual gift, whether digital or tangible in nature.

In another aspect, the system integrates both mobile and web-based interaction with an augmented or virtual reality delivery process. For example, the recipient may be required to use augmented reality to select the placement of a package, such as a vase or picture, within the recipient's dwelling, to finalize the entire challenge. In another aspect, for example, where the package is a ticket to an event, such as a movie or play, or a gift certificate, wherein the gift certificate is redeemable at a store or winery, the system may use GPS and GIS location capabilities in the recipient's mobile phone to request that the recipient send an image to the original gift provider to confirm the use of the ticket or gift card. This image, for example, could be a view of the marquee or a snapshot of the image of a wine bottle, preferably including an image of the recipient, in what is known as a “selfie.”

In an additional embodiment, the inventive subject matter includes a method for multi-player challenges where both the gift provider and recipient engage in the challenge together. In yet another aspect, multiple recipients engage in the challenge together, for example siblings are challenged to solve a challenge to gain access to a group gift.

These and other features of the inventive subject matter will be more readily understood upon consideration of the attached drawings and of the following detailed description of those drawings and the presently-preferred and other embodiments of the inventive subject matter.

### BRIEF DESCRIPTION OF THE SEVERAL VIEWS OF THE DRAWING

For a better understanding of the inventive subject matter, reference is made to the detailed description contained herein and the accompanying drawing figures numbered below which are given by way of illustration only and are not intended to be limitative to any extent. Commonly used reference numbers identify the same or equivalent parts of the claimed invention throughout the several figures. These and other features, aspects and advantages of various embodiments of the inventive subject matter will become better understood with regard to the following description, appended claims, and accompanying drawings where:

FIG. 1 is a block diagram of the system according to the inventive subject matter of the present disclosure;

FIG. 2 is a more detailed illustration of various components of the system and method shown in FIG. 5;

FIG. 3 is an illustration of the structure and interaction of components of the system and method according to the inventive subject matter;

FIG. 4 is a is a block diagram illustrating various exemplary product types according to the inventive subject matter;

FIG. 5 is a flowchart illustrating a top-level view of an embodiment of the method according to the inventive subject matter;

FIG. 6 is a flowchart in greater detail illustrating options for selection of a package, product and challenge;

FIG. 7 is a flowchart in greater detail of additional steps associated with check out;

FIG. 8 is a flowchart in greater detail of additional steps associated with the receive and redeem step;

FIG. 9 is a swim lane flowchart illustrating processes and participants of a first embodiment of a product and challenge integration process according to the inventive subject matter;

FIG. 10 is an illustration of the structure and interaction of components of the system and method directed to a puzzle challenge, according to according to an embodiment of the inventive subject matter.

FIG. 11 is an exemplary view of an initial user interface 6000, according to an embodiment of the inventive subject matter;

FIG. 12 is an example illustration of a puzzle game challenge in a disassembled state, according to an embodiment of the inventive subject matter;

FIG. 13 is an example illustration of a puzzle game challenge in a completed and assembled state, according to an embodiment of the inventive subject matter;

FIG. 14 is an example illustration of a different display of a completed puzzle challenge, according to an embodiment of the inventive subject matter; and,

### OBJECTS

One object of the inventive subject matter is directed to achieving a cognitively enhanced remembrance of the receipt of a gift by one or more target recipients by engaging the recipient in a memorable activity. Another object of the inventive subject matter is to provide an interactive multi-player solution to allow one or more target recipients to participate in challenges to obtain access to one or more digital gifts. Another object of the inventive subject matter is to provide a mechanism by which a gift provider may customize the delivery of a package to one or more target recipients above and beyond the mere delivery of an email notice, text message, social media post or gift card.

### DETAILED DESCRIPTION

The following description is merely exemplary in nature and is in no way intended to limit the invention, the inventive subject matter, its application, or its uses. Before the inventive subject matter is described in further detail, it is to be understood that the invention is not limited to the particular aspects described, as such may, of course, vary. It is also to be understood that the terminology used herein is for describing particular aspects only, and is not intended to be limiting, since the scope of the present invention will be limited only by the appended claims.

Unless defined otherwise, all technical and scientific terms used herein have the same meaning as commonly understood by one of ordinary skill in the art to which this inventive subject matter belongs. Although any methods and materials similar or equivalent to those described herein can also be used in the practice or testing of the inventive subject matter, a limited number of the exemplary methods and materials are described herein.

It must be noted that as used herein and in the appended claims, the singular forms “a”, “an”, and “the” include plural referents unless the context clearly dictates otherwise.

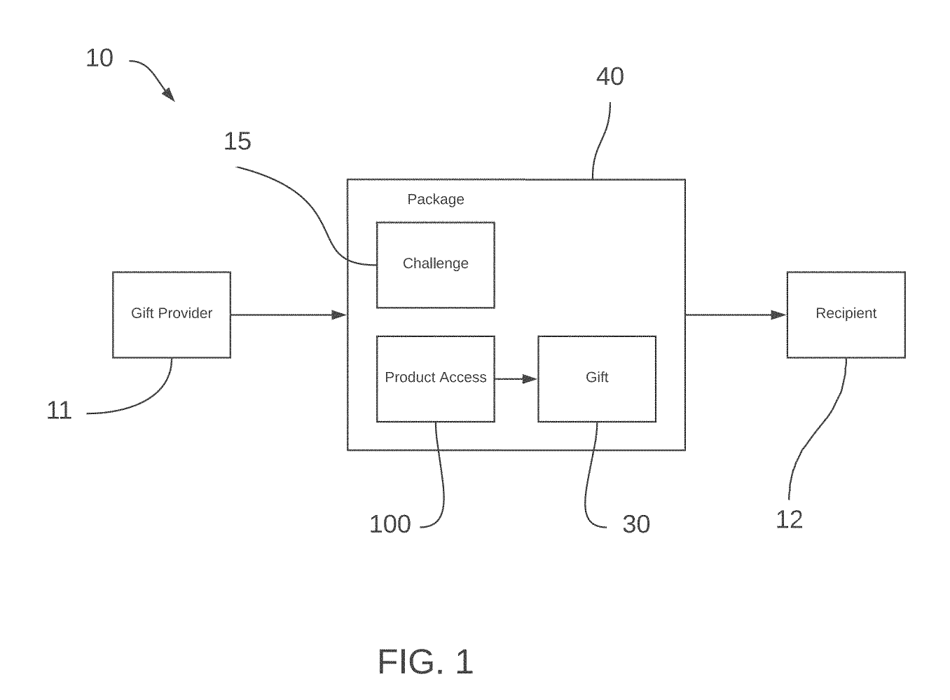

Referring now to FIG. 1, a map of components of the system 10 according to the inventive subject matter of the present disclosure is shown. The system 10 orchestrates and manages all aspects of the delivery of a package 40, comprising a challenge 15 and a gift 30 derived from product access 100, to a targeted recipient 12, as sponsored by a gift provider 11.

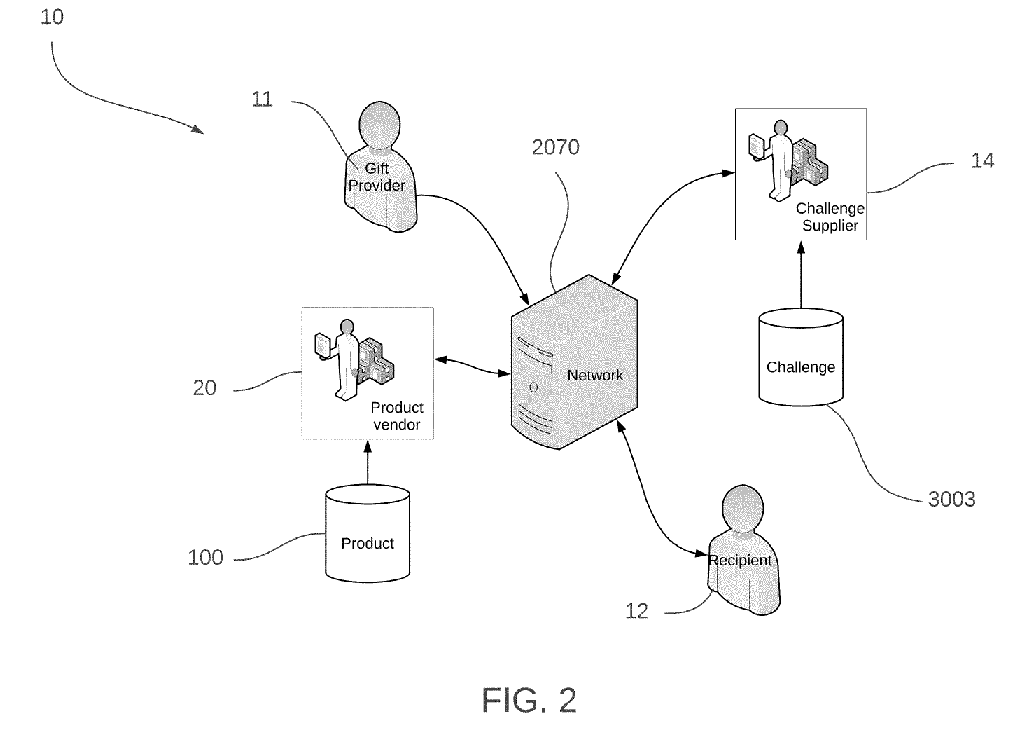

Referring now to FIG. 2, the system 10 comprises a modifiable and scalable digital approach to allow product vendors 20 and challenge suppliers 14 to offer their products 100 and challenges 15 more easily to support a novel gift delivery method 1000 to enhance cognitive retention by the recipient 12 of a gift. The transactions associated with the system 10 and method 1000 occur across a network 2070. The system 10 enables a gift provider 11 to purchase a product 100 to deliver to a desired recipient 12 as a gift 30 in a manner that enhances cognitive retention of the gifting experience along with the identity of the gift provider 11. The gift 30 may be a prepaid gift card 26, redeemable for additional products 100 offered by the product vendor 20.

In one embodiment, the system 10 provides access for a gift provider 11 to purchase a product 100 from a product vendor 20, and a challenge 15 from a challenge supplier 14. In other aspects, the product vendor 20 and challenge supplier 14 may be one in the same entities. The system 10 causes the challenge 15 to be delivered to the recipient 12. The recipient 12 may redeem the gift 30 after completing the selected challenge 15. The gift provider 11, recipient 12, product vendor 20, and challenge supplier 14 interact via a network 2070.

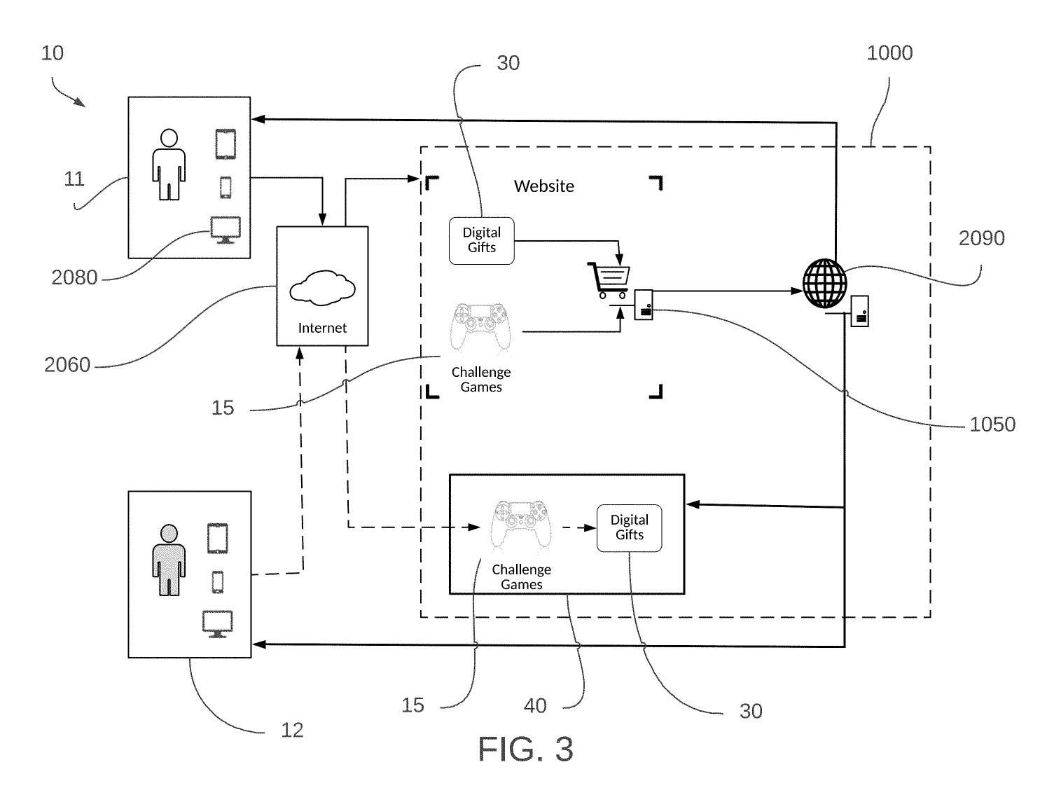

Referring now to FIG. 3, a more detailed illustration of various components of the system 10 and method 1000 of the inventive subject matter is shown. First, a gift provider 11 accesses the Internet 2060 using a computing device 2080. The computing device 2080 establishes a connection with the Internet 2060. The system 10 connects the gift provider 11 for access to a website. The website presents options for consideration by the gift provider 11 to obtain one or more digital gifts 30 and to select one or more challenges 15. The gift provider 11 chooses a digital gift 30. The gift provider 11 then chooses a challenge 15. The gift provider 11 then completes his or her purchase. The system 10 stores the data concerning the gift 30 and the data concerning the challenge 15 on a web server 2090. The system 10 then causes the target recipient of the challenge 15 and gift 30 to be notified through a computing device 2080 with text, email, social message or other digital communication means that they have been presented with the challenge 15. The recipient 12 then accepts delivery of the challenge 15 on his or her computing device 2080. The system 10 then causes the challenge 15 to be presented to the recipient. The recipient 12 attempts to complete the challenge 15. When the recipient 12 has completed the challenge 15, the system 10 causes a notice 22 to be sent to the digital gift supplier, the product vendor 20. The product vendor's 20 gift fulfillment process is initiated, and, the digital gift 30 is delivered to the recipient 12 for use.

The system 10 facilitates integration with curated external games as challenges. Gaines curated for the purpose of providing a challenge 15 to access a digital gift 30 are modified to access the encapsulation process of the system 10. Additional challenges promulgated by the system 10 may comprise the integration of games developed specifically for challenges 15 unique to the system 10.

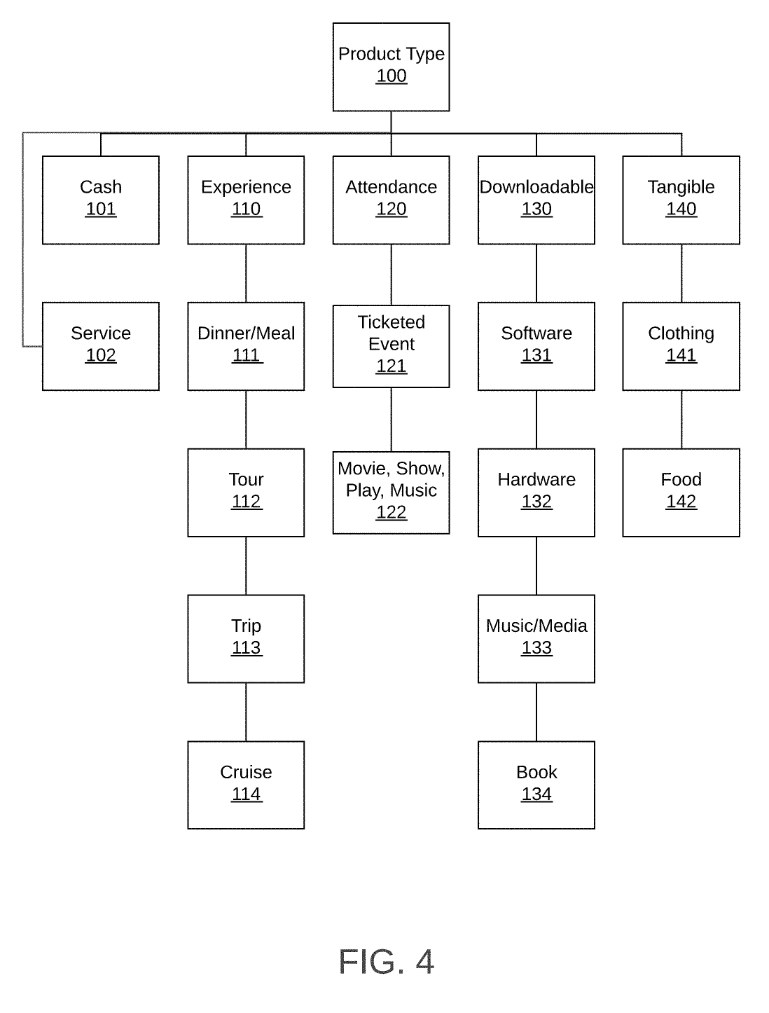

Referring now to FIG. 4, the system 10 may support a plurality of different product types 100. FIG. 4 is a block diagram illustrating various exemplary product types 100 according to the inventive subject matter of the present disclosure. A product type 100 may be cash 101 or a service 102. Additionally, the product type 100 may be in the form of a prepaid experience 110 such as a meal 111, a tour 112, a trip 113, or a cruise 114. A product type 100 may enable attendance 120 at an event, such as a ticketed event 121, movie, show, play, or musical event 122. The product type 100 may be a downloadable 130 such as software 131, access to hardware 132, music 133, or a book 134 in digital form. The product type 100 may likewise exist as a tangible item 140 such as clothing 141 or food 142 (such as, delivery of OMAHA STEAKS).

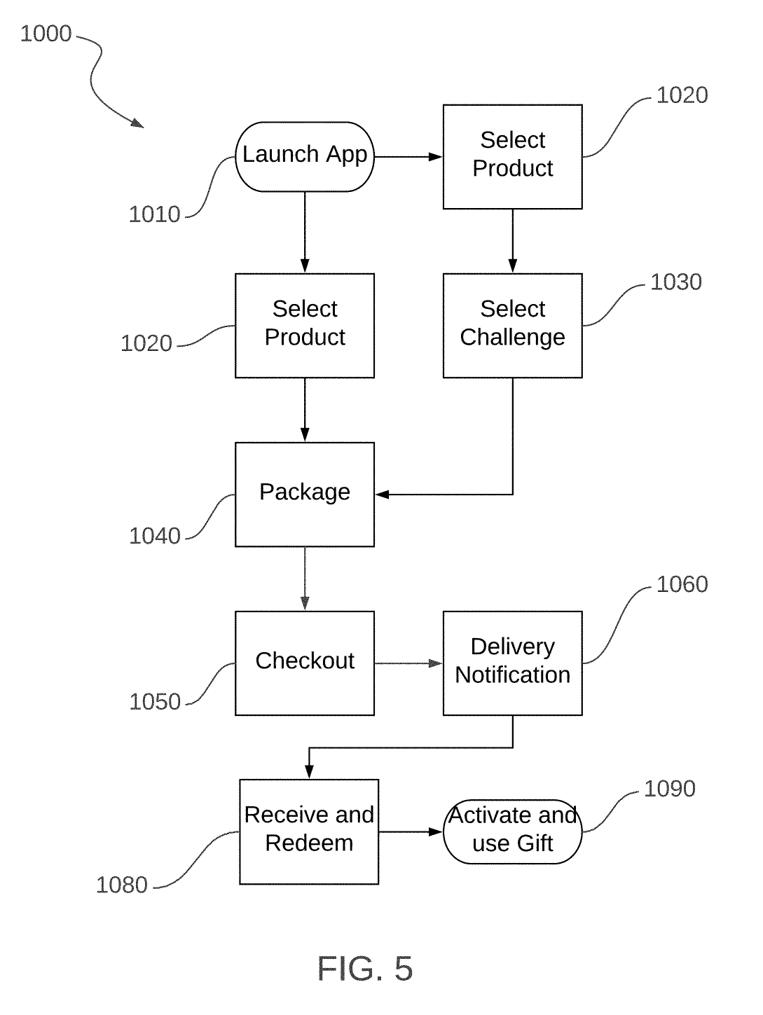

Referring now to FIG. 5, a flowchart illustrating a top-level view of an embodiment of the method 1000 according to the inventive subject matter of the present disclosure is shown. The method 1000 comprises steps by which a gift provider 11 provides a package 40, comprising a challenge 15 and gift 30, to a recipient 12. In a first step 1010, the gift provider 11 activates an application via the network 2070 that enables the purchase of a product 100 and selection of a challenge 15. In step 1020, the gift provider 11 selects a product type 100 from a digital resource maintaining access to the product sources 20. In step 1030, the gift provider 11 selects a challenge 15 for the recipient 12 to complete prior to receiving the selected product 100. Note that the system 10 also allows a gift provider 11 to elect to not send the gift 30 to the recipient 12 if the challenge 15 is not successively completed. Optionally, in step 1040, the gift provider 11 may select from a pre-compiled list of packages 40 which comprise pre-established combinations of products 100 and challenges 15. In step 1050, the gift provider 11 finalizes his or her order and checks out of the purchase process. In step 1060, the system 10 causes a notification 22 to be sent to the targeted recipient 12 indicating that they have received a pending package 40 comprising a challenge 15 to be completed to obtain access to a gift 30. In step 1080, the recipient 12 receives the challenge 15, completes the challenge 15, and triggers release of the gift 30 wherein the gift 30 may be redeemed to obtain access to a product 100. In step 1090, the system will activate access for the recipient 12 to obtain and use the gift 30.

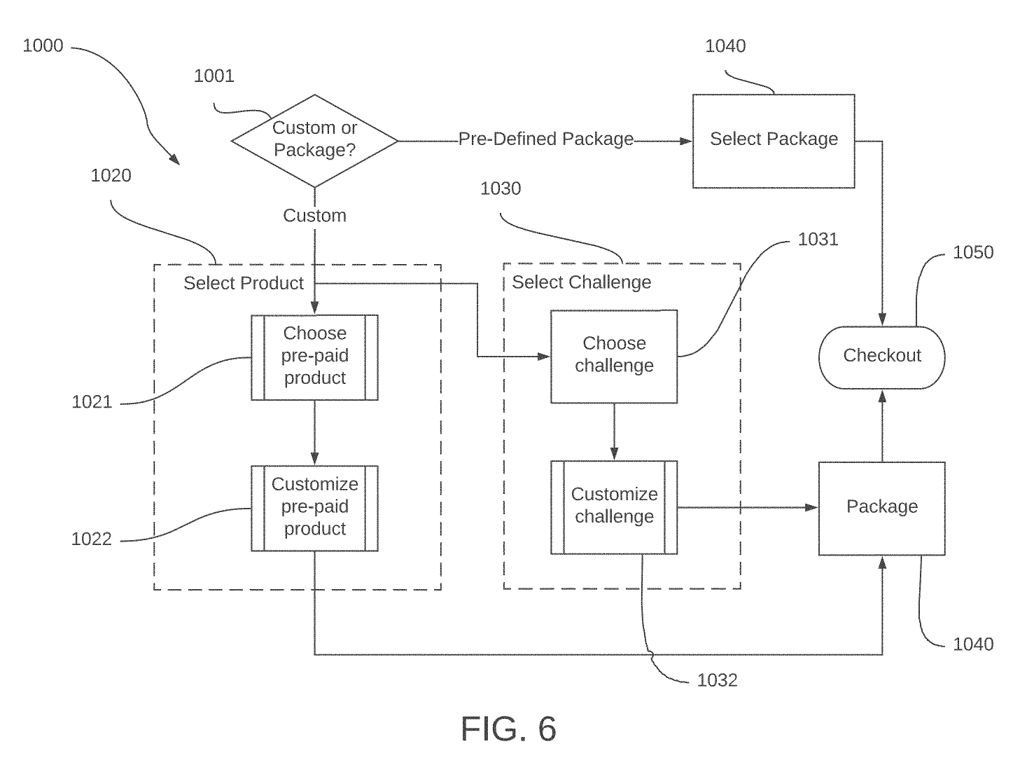

Referring now to FIG. 6, a flowchart in greater detail illustrating options for selection of a package 40, product 100 and challenge 15 is shown. After completion of the launch app step 1010, in step 1001, the system 10 presents a user interface providing the gift provider 11 with options to select either a preconfigured package 1040, consisting of a pre-packaged combination of products 100 and challenges 15, or alternatively, the system 10 presents an option for the gift provider 11 to customize the gift 30 and challenge 15 combination. If the gift provider 11 elects to customize the package, in step 1020, the system 10 presents an interface to the gift provider 11 to select a product 100. At step 1021, the gift provider 11 may elect to select a pre-paid product 100 and at step 1022, the system 10 presents the gift provider 11 with an opportunity to customize the pre-paid product 100. In step 1021, the gift provider 11 selects a product 100 from a list of products 100 offered by the product vendors 20. In one embodiment, the products 100 may be pre-paid gift cards 26 for use at various product vendors 20. In customize product step 1022, the gift provider 11 further customizes the product 100 selected in choose product step 1021. In one embodiment, the gift provider 11 selects the value of the selected pre-paid gift card 26.

Referring still to FIG. 6, the system 10 provides an opportunity for the gift provider 11 to select a challenge 15 in step 1030. In step 1031, the gift provider 11 chooses a challenge 15 from a repository of challenges 15 offered by the challenge suppliers 14. A challenge 15 is any game, puzzle, or activity the gift provider 11 wishes the recipient 12 to complete before receiving a selected product 100 as a gift 30. The challenge supplier 14 may be any content provider that presents an online challenge 15 across the network 2070 via web browser, mobile application, or other medium. In step 1032, the gift provider 11 may customize the selected challenge 15. In one embodiment, the gift provider 11 may further customize the challenge 15 by, for example, modifying the specific content of the challenge 15, such as a game level, desired difficulty, or desired length of the challenge 15. In step 1050, the gift provider 11 checks out and the system 10 will deploy a package 40 to the target recipient 12 consistent with the input from the gift provider 11.

Returning to step 1001 in FIG. 6, if the gift provider 11 elects not to customize their order, in step 1040, the system 10 provides the gift provider 11 with an option to select a pre-determined package 40 comprising a pre-packaged combination of product 100 and challenge 15 from a pre-compiled repository of packages 40, with no additional product 100 or challenge 15 customization available. Whether the gift provider 11 decides to customize their order via select product step 1020 and select challenge step 1030, or select a package 40 in select package step 1040, in step 1050, the gift provider 11 next checks out and the system 10 will deploy a package 40 to the target recipient 12 consistent with the input from the gift provider 11.

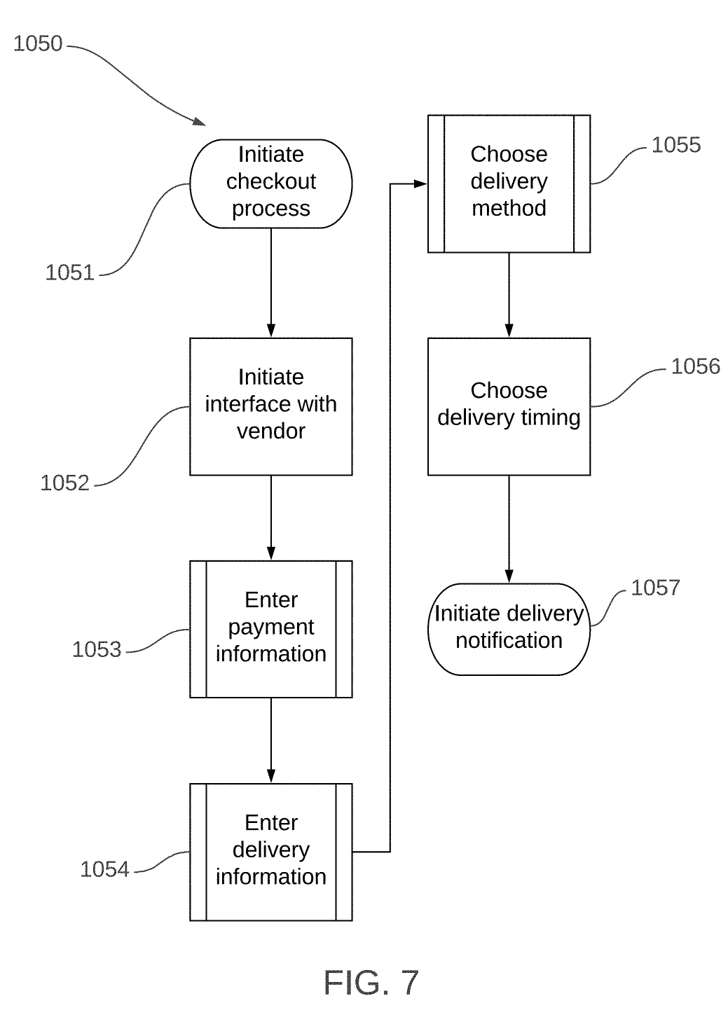

Referring now to FIG. 7, a flowchart 1050 in greater detail of additional steps associated with checking out is shown. In step 1051, the gift provider 11 chooses an icon on the presented interface indicating that they have completed their shopping and wish to checkout. In step 1052, the gift provider 11 connects and initiates an interface with the product vendor 20 offering the selected product 100. In step 1053, the gift provider 11 submits payment information to the product vendor 20 to purchase the selected product 100. In one aspect, the gift provider 11 is not billed for the product 100 during the checkout step 1050, and instead, is not billed until the target recipient 12 successfully completes the associated challenge 15 and takes appropriate action to obtain access to the product 100 associated with the gift 30. In another aspect, the gift provider 11 is billed immediately upon completion of checkout. After entering payment information 1054 in the system software, in step 1054, the gift provider 11 submits information to the system 10 and product vendor 20 identifying the intended recipient 12 with appropriate delivery information. In step 1055, the gift provider 11 chooses a desired delivery modality which is communicated to the product vendor 20 either directly or through transmission by the system 10. In one embodiment, wherein the product 100 is a pre-paid gift card 26 or other item that may be delivered electronically, the gift 30 and challenge 15 may be delivered over the network 2070 via text message, email, or within an application on a mobile device, tablet or desktop computer. In another embodiment, wherein the gift 30 is a physical item, the challenge 15 is still presented to the recipient 12 over the network 2070 while the gift 30 is delivered via physical mail or redeemable at the physical address of the product vendor 20.

Referring still to FIG. 7, in timing step 1056, the system 10 presents options to the gift provider 11 to select a delivery time to deliver a package 40, comprising the challenge 15 and gift 30, to the recipient 12. The gift provider 11 may request immediate delivery to the recipient 12. Alternatively, for example in the case of a holiday gift, the gift provider 11 may select a future calendar date during which the package 40 is delivered to the recipient 12. In one embodiment, the gift provider 11 may trigger the presentation of the challenge 15 at one time, and select a subsequent time to present the gift 30 to the recipient after the completion of the challenge 15.

In step 1057, the system causes a notification 22 to be sent to the recipient 12 that they have received a package 40 comprising a gift 30 and challenge 15. In one aspect, the system will cause the notification 22 to include information concerning the gift 30 that will be received upon completion of the challenge 15. In another embodiment, the recipient 12 will be notified that they may receive a gift 30, the exact gift 30 being revealed after completion of the offered challenge 15.

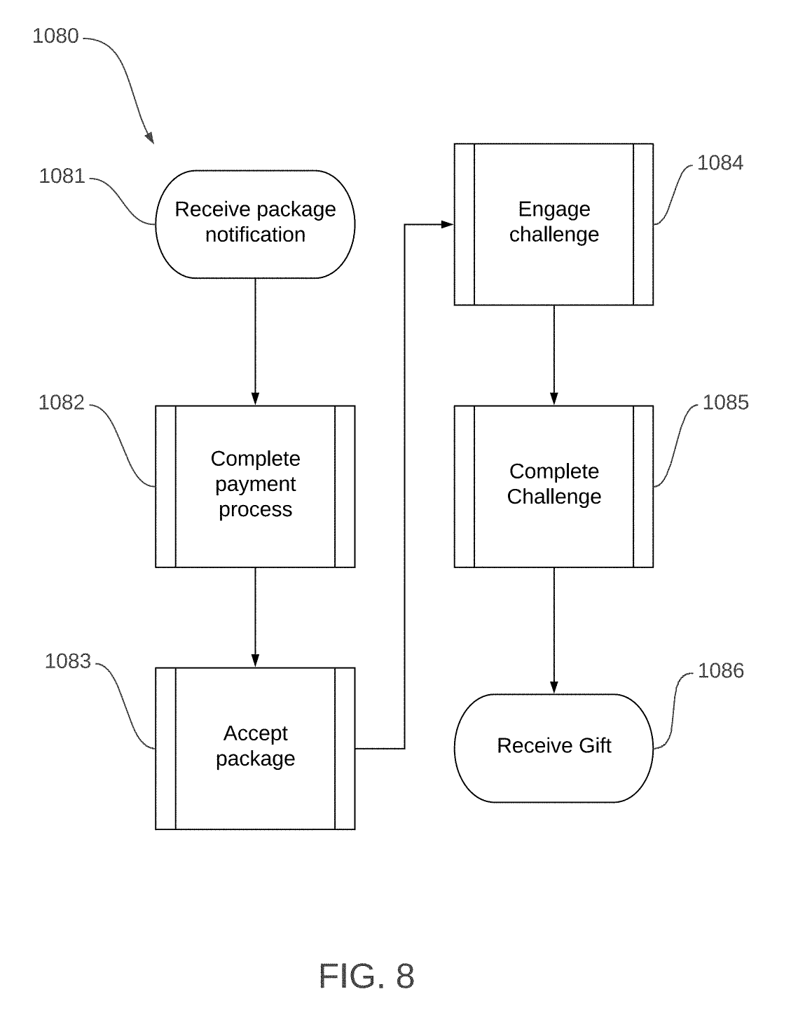

Referring now to FIG. 8, a flowchart 1080 of additional steps associated with the process for receiving and redeeming a gift 30 is shown. In step 1081, the system 10 creates a notification 22 and digitally transmits the notification 22 to the target recipient 12. Once the notification 22 has been transmitted by the system 10 and receipt has been confirmed by the recipient 12, in step 1082, the system 10 processes payment to the vendor 20 of the selected product and the system further bills the gift provider 11 according to the billing information provided earlier during enter payment information step 1053. In step 1083, the recipient 12 accepts the package 40 comprising a gift 30 and challenge 15, and is given the opportunity to attempt the challenge 15. In step 1084, the system 10 allows the recipient 12 to engage in the challenge 15 and attempt completion of the challenge 15.

In step 1085, where the recipient 12 has been able to complete the challenge 15, completion will trigger the system 10 to make the selected product 100 accessible to the recipient 12 as a gift 30. In an alternative version, the system 10 allows a gift provider 11 in customize challenge step 1032 to select a customization option which allows the recipient 12 to “give up,” allowing the skipping of complete challenge step 1085 after a designated number of attempts. In step 1086, the system 10 causes the gift 30 to be delivered to the recipient 12. If the gift 30 is an electronic item, the recipient 12 may receive the gift 30 over the network 2070 either immediately or at a previously designated delivery time. If the gift 30 is a physical item, the gift 30 is flagged for mail delivery, or redemption at the product vendor 20 physical address, either immediately or at the designated delivery time.

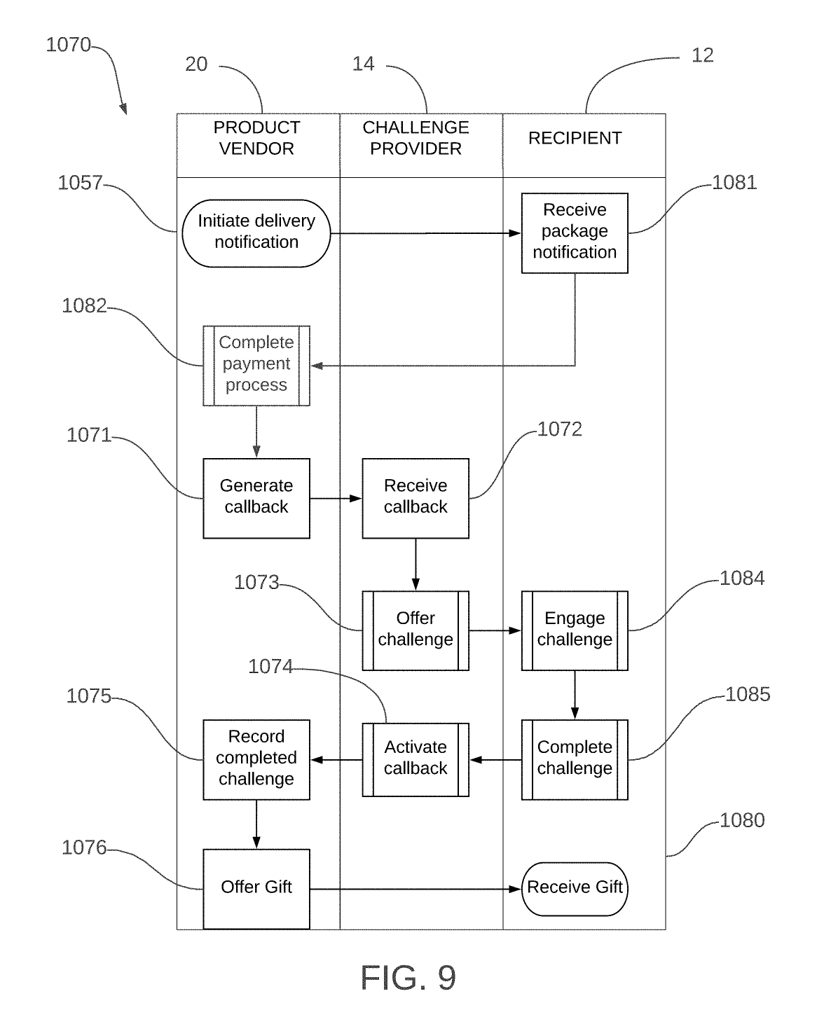

Referring now to FIG. 9, a swim lane flowchart in greater detail illustrating processes and participants of a first embodiment of a product and challenge integration process 1070 according to the inventive subject matter of the present disclosure is shown. The product and challenge integration flowchart 1070, illustrates an exemplary interaction between a product vendor 20, a challenge supplier 14, and a recipient 12. As previously described in initiate delivery notification step 1057, the system 10 supports and orchestrates the interaction between the participants in the product and challenge integration process 1070, according to the following activities. Any reference to actions by the participants in the process are facilitated by the system 10 according to the inventive subject matter described in this disclosure. However, the following description helps to further describe interaction between the participants.

First, in step 1057, a selected product vendor 20 sends a notification 22 to a designated recipient 12, who receives the notification 22 at step 1081. In step 1071, the product vendor 20 generates a callback 24 for delivery to the challenge supplier 14, providing parameters to the challenge supplier 14 for inclusion of the challenge 15 in the package 40. The generated callback 24 may include the selection of the content, length, and difficulty of the challenge 15. Additionally, the callback 24 includes instructions to be executed through the challenge 15 to notify the product vendor 20 once the challenge 15 has been completed. For example, the challenge 15 may be required to make a customized http call to the product vendor 20 once the challenge 15 has been completed, or if the challenge 15 has not been completed and the recipient 12 has abandoned his or her efforts to complete the challenge 15.

In step 1072, the challenge supplier 14 receives the callback 24 with appropriate instructions and parameters generated in step 1071. The challenge supplier 14 processes the instructions from the product vendor 20, and in step 1073, offers the challenge 15 to the recipient 12. In step 1084, the recipient 12 engages the challenge 15. Once the challenge 15 has been completed by the recipient 12, achieving the completion milestone in step 1085, in step 1074, the challenge supplier 14 notifies the product vendor 20 of the completion by activating the callback 24 generated and delivered in step 1072. In step 1075, the product vendor 20 receives the activated callback 24 and confirms and records that that the challenge 15 has been completed. The product vendor 20 then enables the release of the gift 30 to the recipient 12. In step 1076, the product vendor 20 notifies the recipient 12 that they have been awarded the product 100, who then receives the gift 30 in receive product step 1086.

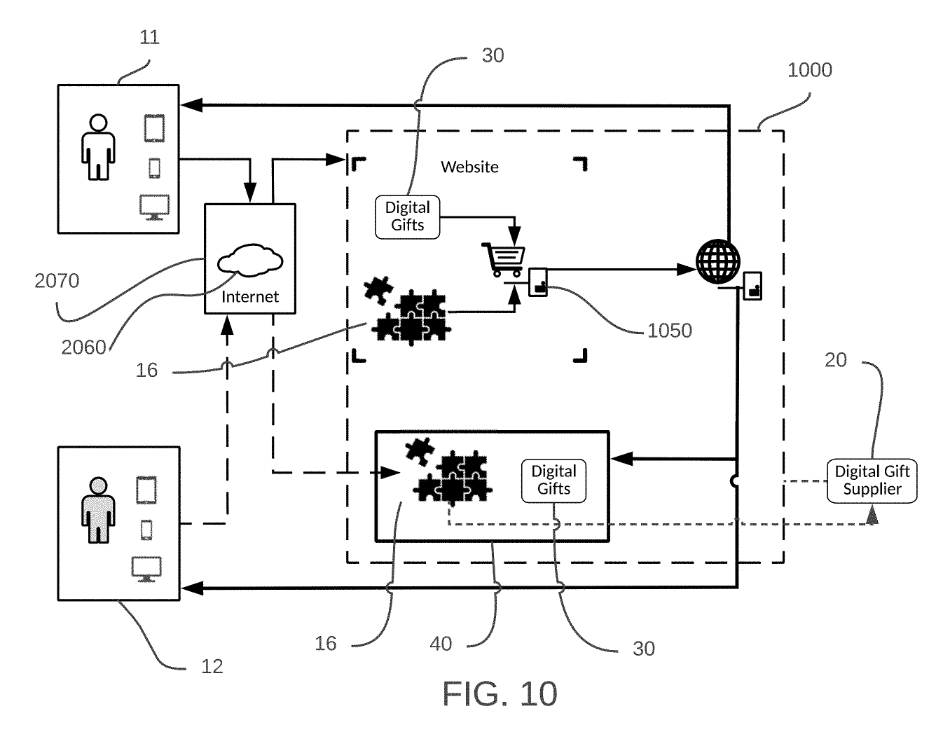

Turning to FIG. 10, a process diagram illustrating the operation of the puzzle embodiment 6000 according to the system 10 and method 1000 associated with the inventive subject matter of this disclosure is shown. First, in step 6010, a gift provider 11 navigates to the application website using a browser to access the system 10. At the start, the software application orchestration module 510 will trigger the game flow for a requested delivery date. The orchestration module 510 sends information concerning the gift provider 11, the recipient 12, an image 6002 for the puzzle, the image dimensions, structure of the puzzle pieces 6001 and the delivery data to the game or challenge engine 310. The system 10 then causes a notification 22 consisting of email or text message to be sent to a target recipient 12, on the established delivery date. The recipient 12 receives either a notification 22 comprising a text message or an email message with various greetings and a hyperlink to access the puzzle challenge 16. Upon receipt of the notification 22, the recipient 12 can elect to immediately access the puzzle challenge 16 or defer to a later time. If the recipient 12 elects to defer to a later time, the system 10 will cause a reminder email or a reminder text message to be sent at a later time or date to the recipient 12. If the recipient 12 selects the option to proceed, the system 10 will cause a browser to launch on the recipient's device that navigates to the puzzle challenge URL. A puzzle engine will render the puzzle on the recipient's screen with the puzzle broken into a plurality of puzzle pieces 6001 randomly distributed about the screen. The recipient 12 will then endeavor to assemble the puzzle pieces 6001 into a completed picture. The recipient 12 may drag puzzle pieces 6001 with a finger, tap to select a puzzle piece 6001 and tap to place a puzzle piece 6001, and flick a puzzle piece 6001 to another side of the screen.

Once the puzzle challenge 16 has been completed by the recipient 12, the image 6002 associated with the puzzle challenge 16 will be displayed to the recipient 12. The display preferably comprises an image 6002 that will be memorable for the recipient 12. Other aspects that may be displayed include a gift card brand image, a QR code, and a barcode. At this juncture, the recipient 12 is prompted to save the image 6002 to device storage 2050 for later use. To enhance the cognitive retention of the image 6002 associated with the puzzle challenge 16, the recipient 12 may also elect to save the image 6002 as the primary screen or screen saver shown when operating his or her laptop, tablet or smart phone, thereby increasing the number of times that the recipient 12 will be exposed to the image 6002, creating a longer-term memory for the recipient 12 of the gift provider 11, the gift 30 and the overall gifting experience. The recipient 12 may also be prompted to rate their experience with the gifting transaction and the associated challenge 16. The recipient 12 may also be prompted to share the experience on social media, once again enhancing the cognitive retention by the recipient 12 of the gift 30 and the source of the gift 30, the gift provider 11. The recipient 12 will likewise be prompted to login or register with the system 10 to save the gift card 26 to an account for future access. The system may also send an email with the gift card 26, QR or barcode to the recipient 12 with redemption and maintenance information. Finally, the system 10 may provide a prompt and an option to the recipient 12 to send an email message or text message to the gift provider 11, thanking them for the gift 30.

Still referring to FIG. 10, the method 1000 is further described with correlation to the various information shown in the illustration:

(a) First, a gift provider 11 accesses the Internet 2060 via a communications network 2070 using a computing device 2080.

(b) The computing device 2080 establishes a connection with the Internet 2060 where access is transmitted to a web server 2090.

(c) The web server 2090 causes a splashpage 6000 to be displayed to the gift provider 11 for access, in this use case, to the BYTEFROST™ eCommerce website.

(d) At the website, the system 10 presents options for consideration by the gift provider 11 to obtain one or more digital gifts 30 and to select one or more digital jigsaw puzzle challenges 16.

(e) The gift provider 11 chooses a digital gift 30, in this use case, an eGift card 26.

(f) The gift provider 11 then chooses a challenge 15, in this use case, a jigsaw puzzle challenge 16.

(g) The gift provider 11 is also given the opportunity to select or upload an image 6002 to be presented via the completed challenge 16.

(h) The gift provider 11 then completes his or her purchase.

(i) The system 10 stores the data concerning the gift 30 and the data concerning the jigsaw puzzle challenge 16 on the web server 2090.

(j) The system 10 then creates a package delivery notification 22 transmitted to the target recipient 12 of the package 40, comprising the puzzle challenge 16 and gift 30, for display and access via a computing device 2080. The notification 22 may be via text, email, social message or other digital communication means.

(k) The recipient 12 then accepts delivery of the package 40 through his or her computing device 2080.

(l) The system 10 then causes the jigsaw puzzle challenge 16 to be presented to the recipient 12.

(in) The recipient 12 engages with the jigsaw puzzle challenge 16 and attempts to assemble the puzzle pieces 6001 into a completed puzzle 6002.

(n) When the recipient 12 has completed the jigsaw puzzle challenge 16, the system 10 causes another notice 22 to be sent to the digital gift supplier, the product vendor 20.

(o) The product vendor's 20 gift fulfillment process is initiated, and,

(p) the digital gift 30 is delivered to the recipient 12 for use.

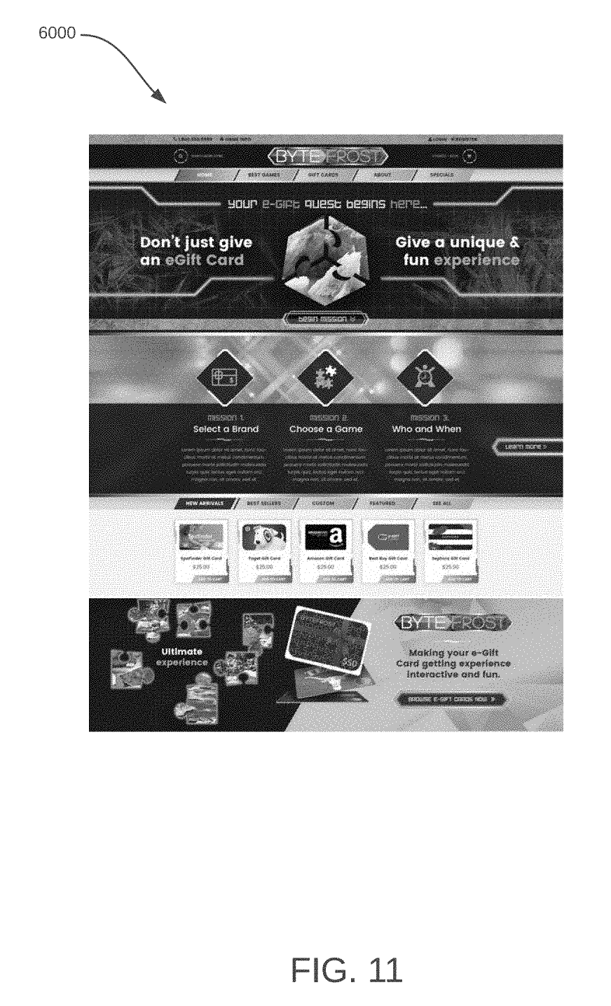

Referring now to FIG. 11, in use and operation, an exemplary view of an initial user interface 6000, a splash page, is presented to either a new user or an existing gift provider 11. A new user is able to register as a gift provider 11 or simply login as an existing gift provider 11. A top-level description of the steps required are shown including selecting a brand, choosing a challenge 15, determining who, a target recipient 12, to send a package 40 to and when. The gift provider 11 is presented with information and options to purchase various products 100 as gifts 30, in this case, various gift cards 26.

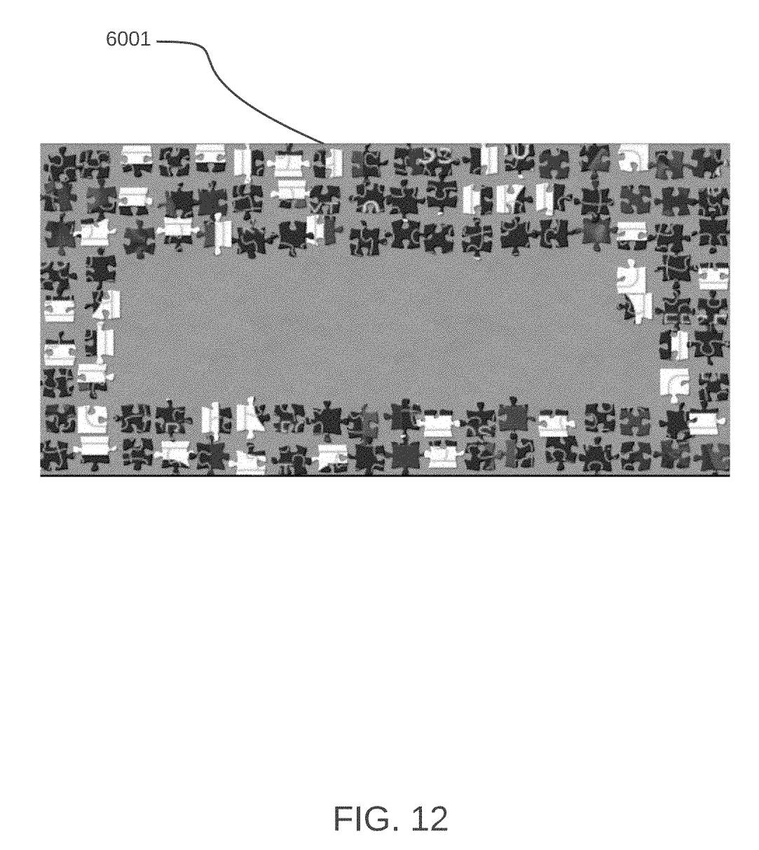

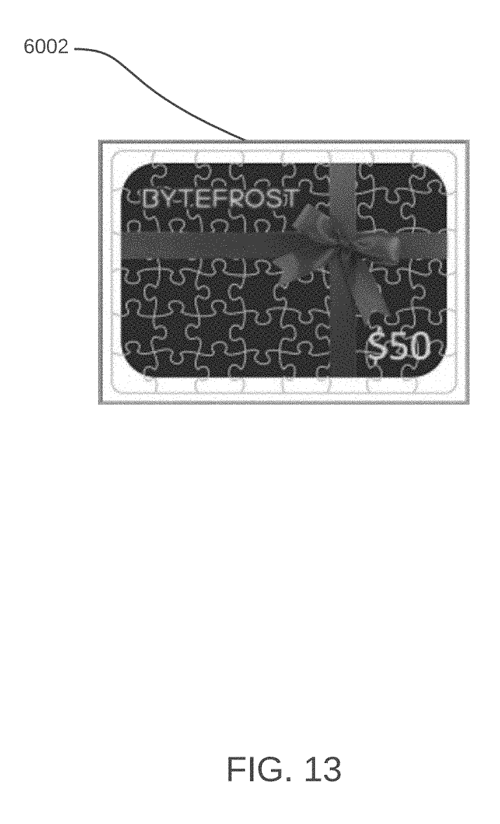

Referring now to FIG. 12 and FIG. 13, an exemplary challenge 15 comprising a digital puzzle challenge 16 for completion by a target recipient 12 is shown. In FIG. 12, an example of the puzzle challenge 16 unassembled is presented. Then, in FIG. 13, a completed version of the puzzle challenge 16 is shown. The completed puzzle challenge 16, in this version, is an illustration of a gift card 26 worth $50 for purchases through a vendor, in this case, BYTEFROST™. The system 10 provides the recipient with an additional interface to obtain access to the purchasing power of the gift card 26. In one version, the recipient 12 simply purchases items online. In another version, the recipient 12 is mailed an actual gift card for use at brick and mortar stores. As shown in FIG. 12, when the puzzle challenge 16 is first engaged by the recipient 12, the puzzle pieces 6001 will be scattered, and the recipient 12 will be required to drag and drop each of the puzzle pieces 6001 until the puzzle challenge 16 has been completed. Once completed, the system 10 will provide means by which the recipient 12 may receive and redeem the gift card 26 for various purchases.

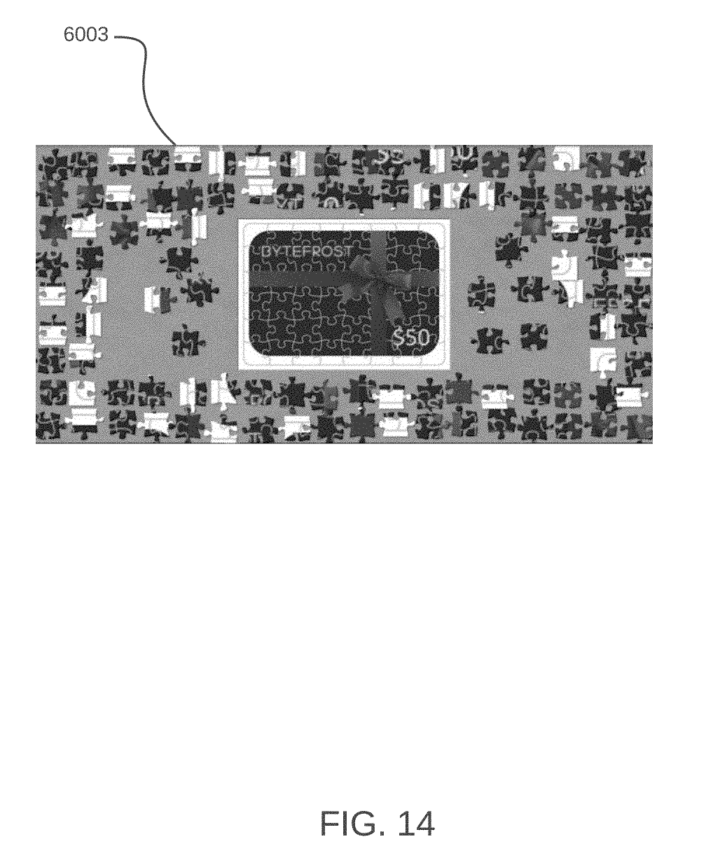

Referring now to FIG. 14, an illustration is shown of a version of a completed puzzle challenge 16 where the image 6002 associated with the completed puzzle challenge 16 is presented within the center of the original scattered puzzle pieces 6001. In another version, the completed image 6002 may comprise a memorable image that the recipient can immediately upload as a screen saver on the recipient's mobile device for further enhanced remembrance.

It will be appreciated that although the embodiments described herein relate to the delivery of challenges associated with gifting, such as the puzzle challenge and eGift card described above, the disclosed process is applicable to many other types of gifts and challenges. Consequently, the inventive subject matter may be made to conform to any of a variety of different challenge types and product types.

Further, it is to be understood that the above described embodiments are merely illustrative of numerous and varied other embodiments which may constitute applications of the principles of the inventive subject matter. Such other embodiments may be readily devised by those skilled in the art, with access to the present disclosure, without departing from the spirit or scope of this inventive subject matter and it is the inventor's intent that these other embodiments be deemed within the scope of her invention.

What is claimed is:

1. A computer-implemented gifting system comprising:
a. a network for communication between participants associated with the gifting system;
b. said network communicating with one or more computing devices;
c. said participants including a gift provider and a recipient;
d. the system configured and operable to allow said gift provider to select a product for delivery to said recipient;
e. the system further configured and operable to support selection, delivery and operation of a digital game challenge;
f. the system further configured to combine said product and said digital challenge into a digital package;
g. the system delivering said digital package to said recipient according to instructions from said gift provider;
h. said recipient able to access said digital package;
i. said recipient engaging with said digital game challenge, such that the interaction with said digital game challenge by said recipient causes said recipient to experience augmented cognitive retention of the gifting experience associated with the receipt of a gift and interaction with said digital game challenge;
j. upon satisfactory completion of said digital game challenge by said recipient, the gifting system presenting said product as a digital gift to said recipient; and,
k. said gifting system providing access to said recipient to redeem said digital gift.

2. The computer-implemented gifting system of claim 1 wherein said digital game challenge is customizable.

3. The computer-implemented gifting system of claim 1 wherein said digital game challenge is a puzzle.

4. The computer-implemented gifting system of claim 1 wherein said participants include one or more gift providers and one or more recipients.

5. A computer and network-implemented method for providing gifts, comprising:
a. a software application operable on a computing device and connected via a network providing access to a gift provider;
b. said software application providing a user interface to said gift provider with options for selecting a product;
c. said gift provider selecting a product;
d. said software application providing a user interface to said gift provider with options for selecting a challenge;
e. said gift provider selecting a challenge;
f. said software application creating a digital package for digital delivery to one or more recipients comprising a challenge and information describing said selected product;
g. said software application providing a checkout process and said gift provider confirming contents of said digital package via said checkout process;
h. said software application sending a notification to said one or more recipients of a pending digital package;
i. said one or more recipients accessing said digital package and beginning said selected challenge;
j. said one or more recipients completing said selected challenge;
k. said software application causing said selected product to be delivered as a gift;
l. said software application providing a user interface to said one or more recipients providing means for accessing said gift for redemption or use.

6. The method of claim 5 wherein said steps b, c and d are replaced by the step of said software application providing a user interface to said gift provider for selecting a digital package comprising a product and a challenge for digital delivery to one or more recipients.

7. The method of claim 5 wherein said software application is configurable to provide a website for the relay of notifications to one or more participants.

8. A software application operable on a mobile device for augmenting cognitive retention of transactions associated with the delivery of digital and tangible products, said software application supporting delivery of tangible and digital gifts, wherein access to said tangible and digital gifts is achieved via the completion of a challenge by a participant.

9. The software application of claim 8 further comprising geolocation functionality to uniquely engage the capabilities, characteristics, features and resources of brick and mortar vendors.

10. The software application of claim 8 deployed in conjunction with one or more other software applications.

11. The software application of claim 10 wherein said one or more other software applications comprise ecommerce applications, social media applications, digital download applications and gift card applications.

12. The software application of claim 9 wherein said geolocation functionality is operable and implemented via the use of augmented reality functionality resident on said mobile device.

13. The software application of claim 8 wherein a puzzle challenge when completed by a recipient comprises a memorable image that the recipient can immediately upload as a screen saver on the recipient's mobile device for further enhanced remembrance.

14. The software application of claim 8 wherein a product type comprises currency or provision of a service.

15. The software application of claim 8 wherein a product type comprises a prepaid experience.

16. The software application of claim 8 wherein said prepaid experience comprises a meal, a tour, a trip, and a cruise.

17. The software application of claim 8 wherein a product type may enable attendance at an event, said event including a ticketed event, said ticketed event including a movie, show, play, or musical event.

18. The software application of claim 8 wherein a product type may comprise a downloadable product, including software, access to hardware, music, games, and a book in digital form.

19. The software application of claim 8 wherein a product type may comprise a tangible item.

20. The software application of claim 8 wherein said tangible item includes clothing and food.
